(19) United States
(12) Patent Application Publication
(10) Pub. No.: US 2003/0072639 A1
(43) Pub. Date: Apr. 17, 2003

(54) Substrate support

(75) Inventors: John M. White, Hayward, CA (US); Akihiro Hosokawa, Cupertino, CA (US)

Correspondence Address: APPLIED MATERIALS, INC., 2881 SCOTT BLVD. M/S 2061, SANTA CLARA, CA, 95050, US

(73) Assignee: Applied Materials, Inc.

(21) Appl. No.: 09/982,406

(22) Filed: Oct. 17, 2001

(51) Int. Cl. B65G 49/07

(52) U.S. Cl. 414/217

(57) ABSTRACT

An apparatus for supporting a substrate is provided. In one embodiment, a substrate support is provided having a body and an upper portion having a socket and ball adapted to minimize friction and/or chemical reactions between the substrate support and the substrate supported thereon. The substrate supports may be utilized in various chambers such as load locks and chambers having thermal processes.

### SUBSTRATE SUPPORT

This application relates to United States Patent Application No. ______ (Attorney Docket No. 6181/AKT/BG), filed Sep. 24, 2001, which is hereby incorporated by reference in its entirety.

### BACKGROUND OF THE INVENTION

1. Field of the Invention

Embodiments of the invention relate to a substrate support.

2. Description of the Related Art

Thin film transistors have been made heretofore on large glass substrates or plates for use in monitors, flat panel displays, solar cells, personal digital assistants (PDA), cell phones, and the like. The transistors are made by sequential deposition of various films including amorphous silicon, both doped and undoped silicon oxides, silicon nitride, and the like in vacuum chambers. One method of deposition for thin films for transistors is chemical vapor deposition (CVD).

CVD is a comparatively high temperature process requiring that substrates withstand temperatures on the order of 300 degrees Celsius to 400 degrees Celsius, with higher temperature processes exceeding 500 degrees Celsius envisioned. CVD film processing has found widespread use in the manufacture of integrated circuits on substrates. However, since glass is a dielectric material that is very brittle and is subject to sagging, warping or cracking when heated to high temperatures, care must taken be to avoid thermal stress and resulting damage during heating and cooling.

Systems exist currently to preheat substrates prior to processing and to conduct post-processing heat treatment operations. Conventional heating chambers have either one or more heated shelves for heating one or a plurality of substrates. Glass is typically supported above a shelf on spacers to improve heat uniformity and throughput. To minimize costs, conventional spacers are typically formed from easily machined metals, such as stainless steel, aluminum, aluminum nitride, and the like. However, conventional spacers may mar or otherwise damage the surface of the glass, possibly resulting in imperfections in the glass surface. For example, annealing to produce low temperature polysilicon film requires heating the substrate to about 550 degrees Celsius, which can cause about 4 mm of thermal expansion in a 900 mm substrate. The thermal expansion results in the glass sliding across the spacers on which the glass is supported during heating and cooling. The resulting friction between the glass and spacers has been shown to cause scratches, cracks, and other deformations in substrates. For example, substrates are often cleaved into multiple panels and may break along a scratch or other defect instead of along a desired location, rendering one or more substrates defective.

In some cases, it is believed that portions of the spacer in contact with the glass may react with and temporarily bond to the glass. When these bonds are later broken, residues of the earlier reaction remain on the spacer, increasing the potential of damage to subsequent substrates during processing. In addition, the residue may become a source of contamination within a heat treatment chamber. Moreover, the residue from the bond between a substrate and a spacer may act as a catalyst for subsequent chemical reactions between the spacer and other substrates, or further degrade a spacer support surface or the lifetime of the spacer.

Therefore, there is a need for a support that reduces or eliminates substrate damage during processing.

### SUMMARY OF THE INVENTION

In one aspect of the invention, an apparatus for supporting a substrate is provided. In one embodiment, an apparatus for supporting a substrate includes a first portion and second portion. The second portion comprises a socket that retains a ball. The ball is adapted to support a substrate thereon while minimizing friction and/or chemical reactions between the substrate and the ball.

In another embodiment, an apparatus for supporting a substrate is provided that includes a chamber body having at least one support member coupled thereto. One or more balls are disposed on the support member. The balls are rotatably adapted to support the glass substrate in a spaced-apart relation to the support member. In other embodiments, the apparatus is useful in heating chambers and load lock chambers where damage or contamination of the substrate is undesired during thermal changes in the substrate.

### BRIEF DESCRIPTION OF THE DRAWINGS

So that the manner in which the above-recited features, advantages, and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a sectional view of one embodiment of a heating chamber having a plurality of support members and spacers.

FIG. 2 is a plan view of one embodiment of a shelf/support member having a plurality of spacers disposed thereon

FIG. 3 is a side view of one embodiment of a conventional spacer.

FIG. 4A is a sectional view of one embodiment of a spacer of the invention.

FIG. 4B is a sectional view of another embodiment of a spacer of the invention.

FIG. 5 is a sectional view of one embodiment of a ball taken along section line 5--5 of FIG. 4A.

FIG. 6A is a sectional view of another embodiment of a spacer of the invention.

FIG. 6B is a sectional view of another embodiment of a spacer of the invention.

FIG. 6C is a sectional view of another embodiment of a spacer of the invention.

FIG. 7 is a sectional view of another embodiment of a spacer of the invention.

FIG. 8 is a sectional view of another embodiment of a spacer of the invention.

FIG. 9 is a sectional view of the spacer of FIG. 8 taken along section line 9--9 of FIG. 8.

FIG. 10A is a sectional view of one embodiment of a load lock chamber of a support member having a plurality of spacers disposed thereon.

FIG. 10B is a sectional view of another embodiment of a load lock chamber of a support member having a plurality of spacers disposed thereon.

### DETAILED DESCRIPTION OF THE PREFERRED EMBODIMENTS

The invention generally relates to a spacer for supporting substrates that is advantageously suited to reduce substrate damage. Although the spacer is particularly useful in chambers where the substrate undergoes a change in temperature, the spacer is suitable for use in other chambers where avoidance of substrate scratching is desired.

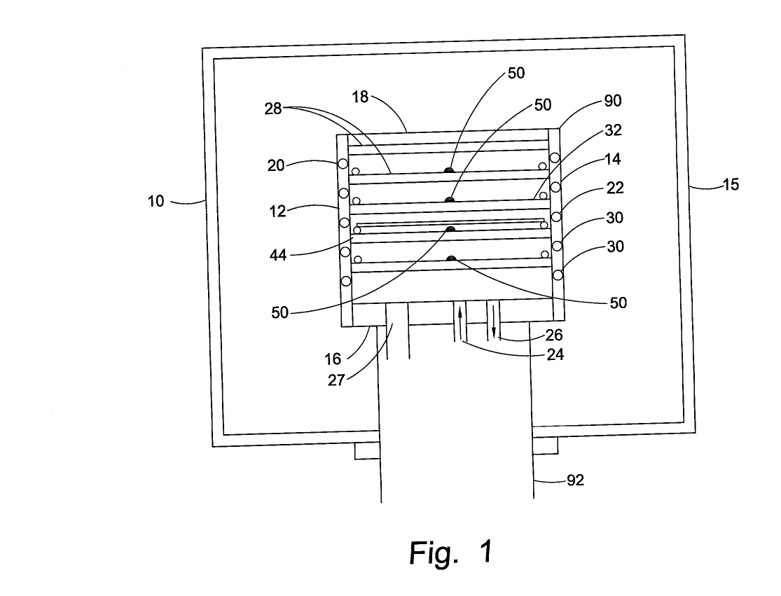

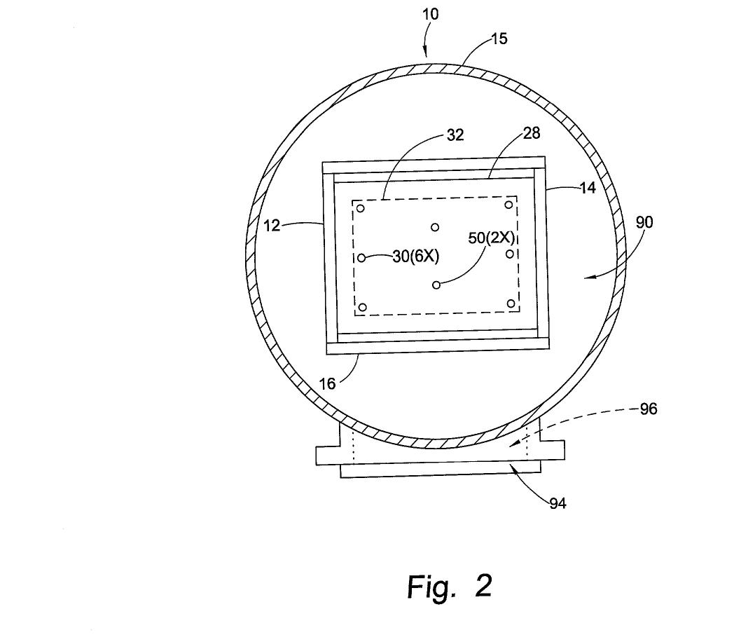

FIG. 1 illustrates a glass substrate 32 disposed within a representative heating chamber 10 supported on a plurality of spacers 30, 50. The heating chamber 10 includes a cassette 90 movably supported within the chamber 10 by a shaft 92. The cassette 90 comprises sidewalls 12, 14, a bottom wall 16 and a lid 18. The heating chamber 10 includes a sidewall 15. A port 96, shown in phantom in FIG. 2, disposed in the sidewall 15 adjacent to a processing system (not shown) is fitted with a slit valve 94 through which glass substrates 32 can be transferred from the processing system into and out of the cassette 90 within the heating chamber 10.

Returning to FIG. 1, the sidewalls 12 and 14 are fitted with suitable heating coils 20, 22 for controlling the temperature of the cassette 90. The heating coils 20, 22 may be a resistive heater and/or a conduit for circulating a heat transfer gas or liquid. The bottom wall 16 is fitted with inlet and outlet pipes 24 and 26, respectively, for circulation of temperature controlled fluid and/or a channel 27 for routing wires for heating coils 20, 22 which are connected to a power source (not shown).

The interior of the sidewalls 12, 14 are fitted with a plurality of support members 28. In the embodiment depicted in FIG. 1, the support members 28 are thermally conductive shelves which are disposed between the walls 12, 14. The support members 28 make good thermal contact with the walls 12, 14 to allow rapid and uniform control of the temperature of the support members 28 and glass substrate 32 disposed thereon by the coils 20, 22. Examples of materials that may be used for the support members 28 include, but are not limited to, aluminum, copper, stainless steel, clad copper and the like. Alternatively, the heating coils 20, 22 may be embedded in the support members 28.

As illustrated in FIG. 2, one or more outer spacers 30 are suitably arranged on the support member 28 to support the perimeter of the glass substrate 32. One or more inner spacers 50 are disposed on the support member 28 to support the inner portion of the glass substrate 32. In the embodiment depicted in FIG. 2, three spacers 30 are disposed on opposing sides of the support member 28 to support the perimeter of the glass substrate 32 while two spacers 50 are disposed inward of the spacers 30 to support a center portion of the glass substrate 32. Other configurations may be alternatively utilized.

Returning to FIG. 1, the spacers 30, 50 serve to support the glass substrates 32 within the cassette 90 so that there is a gap 44 between the support members 28 and the glass substrates 32. The gap 44 prevents direct contact of the support members 28 to the glass substrates 32, which might stress and crack the glass substrates 32 or result in contaminates being transferred from the support members 28 to the glass substrates 32. Glass substrates 32 within the cassette 90 are heated indirectly by radiation and gas conduction rather than by direct contact between the glass substrates 32 and the support members 28. Additionally, interleaving the glass substrates 32 and the support members 28 provides heating of the glass substrates 32 from both above and below, thus providing more rapid and uniform heating of the glass substrates 32.

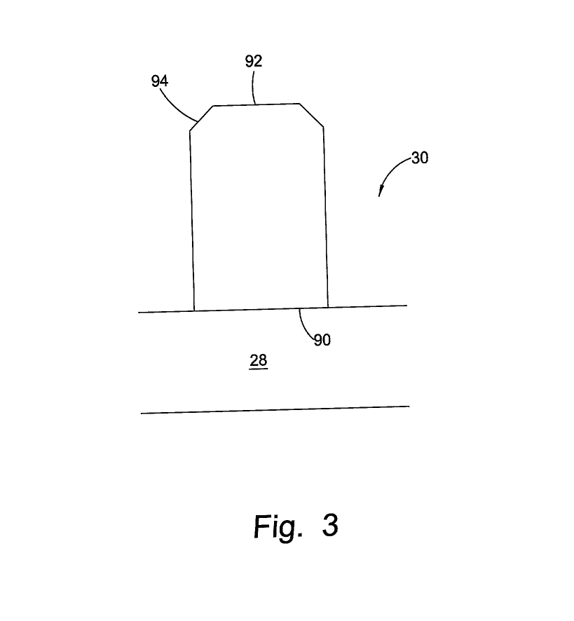

FIG. 3 is a side view of one embodiment of the outer spacer 30. The outer spacer 30 is typically comprised of stainless steel and is cylindrical in form. The outer spacer 30 has a first end 90 and a second end 92. The first end 90 is disposed on the support member 28. The second end 92 supports the glass substrate 32 in a spaced-apart relation to the support member 28. The edge of the second end 92 typically includes a radius or chamfer 94. The second end 92 may alternatively comprise a full radius to minimize the contact area with the substrate.

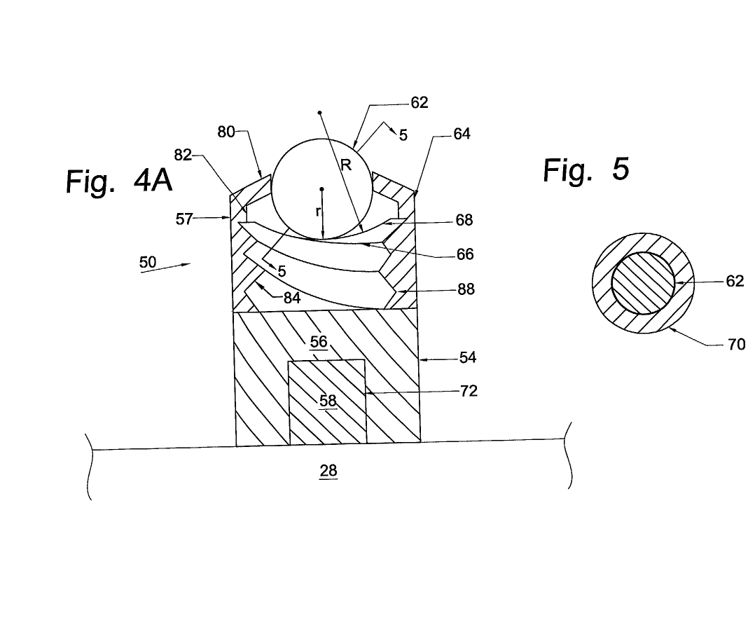

FIG. 4A is a sectional view of one embodiment of the inner spacer 50. Outer spacer 30 may optionally be configured similarly as well. Material used to form the inner spacer 50 may be selected for ease of fabrication and in some embodiments, low costs. The inner spacer 50 is typically fabricated from stainless steel, low carbon steel, ICONEL®, nickel alloys or other suitable material.

The inner spacer 50 generally includes a first portion 56 and a second portion 57. The first portion 56 typically has a cylindrical cross section although other geometries may be utilized. The second portion 57 includes a socket 64 that retains a ball 62 that makes contact with and supports the glass substrates 32.

In one embodiment, the first portion 56 has a hollow center 72 adapted to receive a mounting pin 58 projecting from the support member 28. The pin 58 positions the inner spacer 50 upon its representative support member 28 inside the cassette 90. One advantage of using the mounting pin 58 instead of mounting the inner spacer 50 directly onto the support member 28 is that material selection criteria for the inner spacer 50 and the support member 28 may differ. By using the pin 58, the inner spacer 50 may expand and contract separately from the expansion and contraction of the adjacent support member 28. The inner spacers 50 may alternatively be attached to the support member 28 using other methods or devices. For example, adhering, press fitting, welding, riveting, screwing and the like, may be used to attach the inner spacers 50 to a support member 28. It is to be appreciated that other methods of attaching or fixing embodiments of the glass spacers 50 to the support member 28 are also contemplated.

The second portion 57 of the inner spacer 50 generally comprises the ball 62 and the socket 64. In one embodiment, the socket 64 includes a ball support 66 comprising a curved surface 68 having a radius “R”. The curved surface 68 of the ball support 66 provides a single contact point with the ball 62 that has a radius “r” that is smaller than the radius “R”.

In the embodiment depicted in FIG. 4A, an outer portion 88 of the ball support 66 is threaded and engages an inner portion 84 of the socket 64 that forms part of a cylindrical sidewall 82 for retaining the ball 62. The sidewall 82 has a generally tapered, swaged or otherwise formed end 80 that retains the ball 62 within the socket 64. Typically, a small clearance is provided between the ball 62 and end 80 to allow the ball 62 to rotate and/or more laterally within the socket. Alternatively, the end 80 and sidewall 82 may be configured to allow the ball 62 to roll across the ball support surface 66 as the substrate 32 moves thereover (see FIG. 4B). The lateral movement of the ball 62 relative to the center support 30 allow the substrate 32 roll across the ball 62 without scratching. Additionally, the conical surface of the ball support surface 66 centers the ball 62 within the socket 64 when the substrate 32 is removed and returns the center support 30 to a configuration ready for the next substrate. In other words, the conical ball support surface 66 re-centers the ball 62 once the substrate is removed. In other embodiments, the ball support 66 may comprise other surface geometries for contacting and retaining the ball 62.

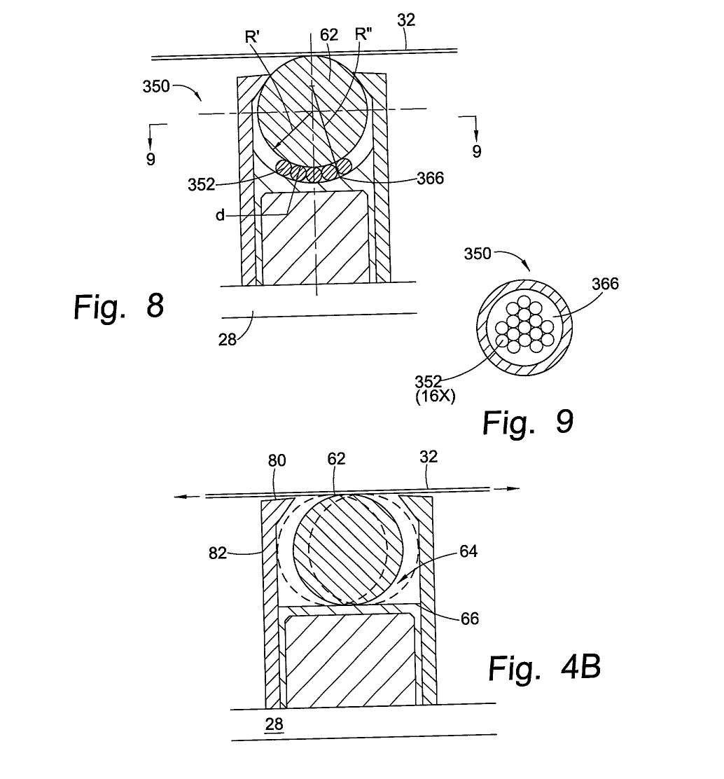

FIG. 5 is a sectional view of one embodiment of the ball 62 taken along section line 5--5 of FIG. 4A. The ball 62 is generally comprised of either metallic or non-metallic materials. The ball 62 may additionally provide friction reduction and/or inhibit chemical reactions between the ball 62 and the glass substrate 32. Typically, the ball 62 is comprised of a metal or metal alloy, quartz, sapphire, silicon nitride or other suitable non-metallic materials. In one embodiment, the ball 62 has a surface finish of 4 micro-inches or smoother.

Optionally, the ball 62 may be coated, plated, or electropolished with a coating layer 70. For example, the coating layer 70 may have a sufficient thickness to provide a barrier layer that reduces friction between the ball 62 and the glass substrate 32. The reduced friction between the glass substrate 32 and the ball 62 substantially prevents damage to the glass substrate 32 caused by rubbing, vibration, thermal expansion, or other contact between the glass substrate 32 and the ball 62. The coating layer 70 may additionally or alternatively provide reduced chemical reactions between materials comprising the ball 62 and the glass substrate 32. In alternate embodiments, other portions of spacer 50 may be coated similarly to reduce friction and/or chemical reaction therebetween.

The coating layer 70 capable of reducing or eliminating friction between the ball 62 and the glass substrate 32 may be deposited by means of chemical vapor deposition (CVD) nitration processes, physical vapor deposition (PVD) sputtering processes, spraying, plating or other processes. In one embodiment, the coating layer 70 has a thickness of at least about 3 microns. In another embodiment, the coating layer 70 is formed to a thickness from between about 3 microns to about 20 microns. In another example, the ball 62 as described above may be placed in a reaction chamber and exposed to an atmosphere comprising ammonia, and/or nitrogen, and/or hydrogen, and/or other reducing gasses to form a nitration coating layer upon the exposed surfaces of the ball 62. In another embodiment, the coating layer 70 is formed by a sputtering process such as PVD to form a nitrated surface on the outer surface of the ball 62 and comprises, for example, titanium nitride.

The surface coating layer 70 generally provides a smooth outer surface to ball 62. It is believed that the alternate embodiments described above of the surface coating layer 70 maintain a smooth surface at least as smooth as the original finish of the ball 62. Alternatively, the coating layer 70 may be processed, for example by electropolishing or other methods, to improve the finish of the coating layer 70. It is also believed that inner spacers 50, having a surface coating layer 70 described above, will reduce the friction between the glass substrate 32 supported on the inner spacer 50 and, in some embodiments, will also or alternatively reduce chemical reactions between contaminants within the ball 62 and/or the glass 32 disposed thereon. Optionally, the coating layer 70 may be applied to the outer spacer 30.

It is to be appreciated that an inner spacer 50 fabricated in accordance with aspects of the present invention is suited for heat treatment operations conducted above 250 degrees Celsius. Other heat treatment operations may also be performed using the inner spacer 50 of the present invention, such as the heat treatment processes used in the fabrication of low temperature polysilicon. It is believed that spacers 50 fabricated in accordance with the present invention are suited for heat treatment operations conducted above about 450 degrees Celsius, up to and including 600 degrees Celsius, depending upon the application and glass material properties. It is further believed that spacers 50 fabricated in accordance with the present invention will reduce the incidence of friction occurring as the glass substrate 32 moves over the inner spacers 50. Further, it is believed that the surface coating layer 70 described above may provide an additional protective layer that both reduces the likelihood of friction damage between the ball 62 and the glass substrate 32 to be supported, while also acting as a barrier layer to prevent reaction between either contaminants or metals within ball 62 and the glass substrate 32.

Embodiments of the inner spacer 50 have been shown and described above as a center support to reduce substrate damage. The embodiments described above illustrate an inner spacer 50 as a center support while conventional outer spacers 30 may be used for support of the periphery of glass substrate 32. It is to be appreciated that some or all of the outer spacers 30 may optionally be configured similar or identical to the inner spacers 50.

While the inner spacers 50 have been described with regard to particular materials, it is to be appreciated that other heat treatment applications may utilize spacers 50 fabricated from other, different materials, and may use alternative materials for coating layers 70 other than those described above.

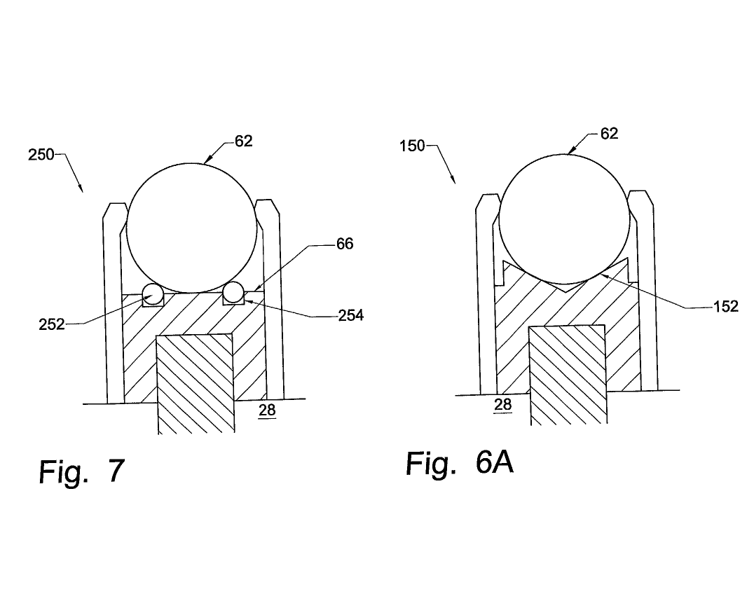

FIG. 6A depicts another embodiment of an inner spacer 150. The inner spacer 150 is configured similar to the inner spacer 50 except the inner spacer 150 supports the ball 62 on a conical surface 152. The conical surface 152 generally centers the ball 62 within the inner spacer 150 while allowing the ball 62 to rotate substantially freely.

FIG. 6B depicts another embodiment of an inner spacer 600 wherein a ball support surface 612 of the spacer 600 is incorporated into the support members 28. The ball 62 is seated on each ball support surface 612 and maintains the substrate 32 and the support member 28 in a spaced-apart relation. The ball support surface 612 may be flat, conical, spherical or other geometry that allows the ball 62 to move laterally and/or rotate within the spacer 600.

FIG. 6C depicts another embodiment of an inner spacer 650 wherein closer spacing between the substrate 32 and the support member is desired, for example, to enhance thermal conductivity. A ball support surface 602 is recessed in the support member 28 to a depth that allows a distance 604 between the ball 62 and support member 28 to just allow clearance between the substrate 32 and the support member 28. The ball support surface 602 may be flat, conical, spherical or other geometry that allows the ball 62 to move laterally and/or rotate within the spacer 650 to prevent scratching or other damage to the substrate 32. A retaining ring 606 may be optionally disposed in a sidewall 608 coupling the ball support surface 602 to the surface of the support member 28 to prevent the ball 62 from dislodging from the support member 28. The support member 28 additionally includes a plurality of lift pins 610 (one of which is shown). The lift pins 610 may be actuated through conventional devices to allow access for a substrate transfer mechanism (not shown) between the substrate 32 and the support member 28 to facilitate substrate transfer.

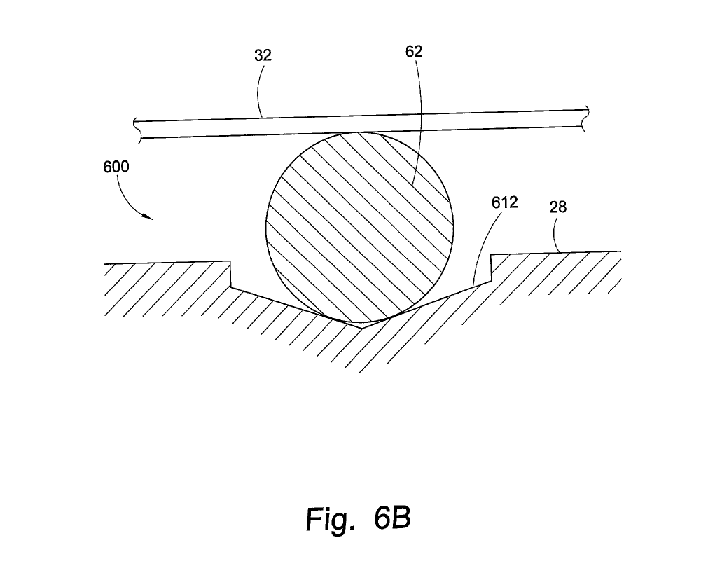

FIG. 7 depicts another embodiment of an inner spacer 250, The inner spacer 250 is configured similar to the inner spacers 50 and 150 except the inner spacer 250 supports the ball 62 on a plurality of internally disposed support balls 252. The support balls 252 are generally disposed in individual depressions 254 in the ball support surface 66. Alternatively, the depressions 254 may comprise a single ring or groove that retains multiple support balls 252. The support balls 252 generally centers the ball 62 within the inner spacer 250 while allowing the ball 62 to rotate substantially freely as the substrate moves thereover.

While the invention has been described for use with glass substrates 32, other embodiments of the inner spacers of the present invention may be used to reduce friction damage and/or chemical reaction between the inner spacers and different substrate materials. While the invention has been described as used in the heating system 10 described above, other heat treatment systems and chambers may be used. Methods and apparatus of the present invention may be practiced independently and irrespective of the type of chamber in which the embodiment of the present invention is employed.

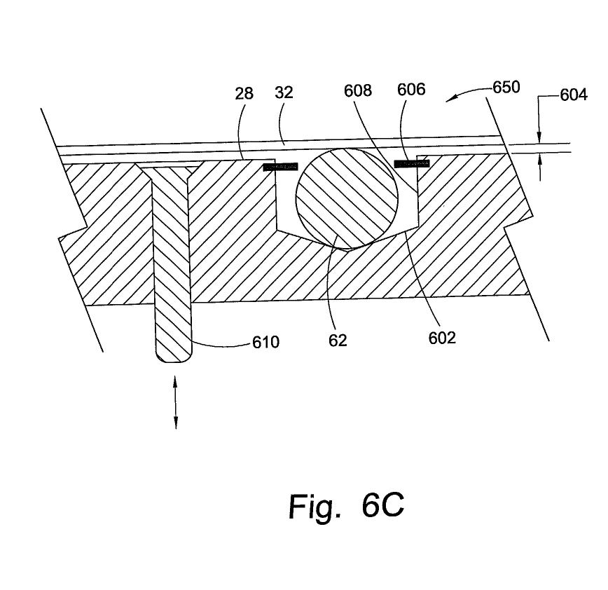

FIG. 8 depicts another embodiment of an inner spacer 350. The inner spacer 350 is configured similar to the inner spacers 50, 150 and 250 except the inner spacer 350 supports the ball 62 on array of support balls 352. The ball 62 generally has a radius R′ and the support balls 352 have a diameter d. The support balls 352 are generally disposed on a ball support surface 366. The ball support surface 366 generally has a radius R″ which is greater than the sum of R′+d. The larger radius of the ball support surface 366 generally allows the ball 62 to rotate freely and/or move laterally across the ball support surface 366 as the substrate 32 moves thereover.

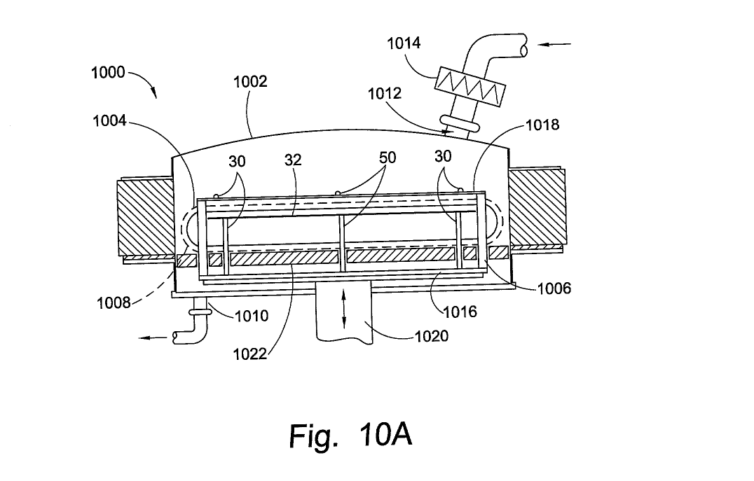

FIG. 9 depicts a sectional view of the inner spacer 350 taken along section line 9--9 of FIG. 8 illustrating one embodiment of an array of support balls 352 comprising sixteen (16) support balls 352. Embodiments having arrays comprising different amounts of support balls 352 are envisioned.

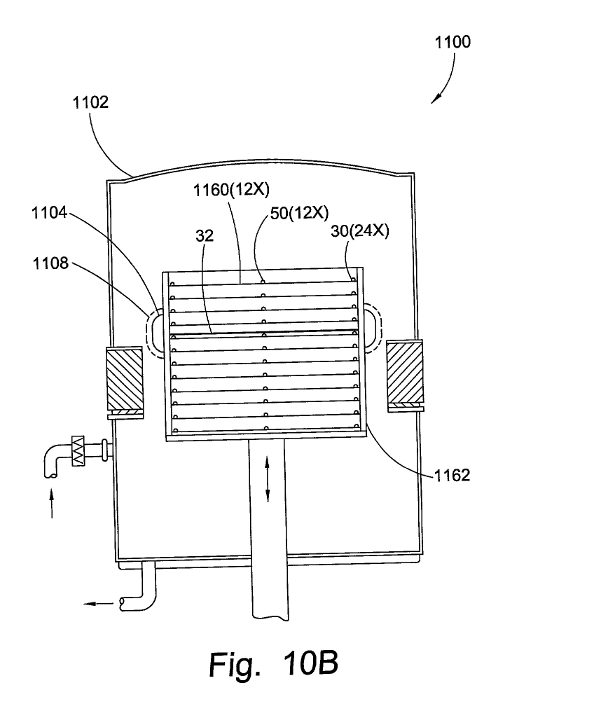

FIG. 10A depicts a sectional view of one embodiment of a load lock chamber 1000 and at least one inner spacer 50 disposed therein. The load lock chamber 1000 generally includes a chamber body 1002 having two glass transfer ports 1004 (only one is shown in FIG. 10A). Each glass transfer port 1004 is selectively sealed by a slit valve 1008 (shown in phantom). The load lock chamber 1000 is disposed between a first atmosphere and a vacuum atmosphere, contained, for example, in chambers (not shown) coupled respectively to the transfer ports 1004, and is utilized to permit transfer of the glass substrate 32 into and out of the vacuum atmosphere through adjacent transfer ports 1004 without loss of vacuum.

The chamber body 1002 additionally includes a pumping port 1010 through which pressure within the chamber body 1002 may be regulated. Optionally, the chamber body 1002 may include a vent 1012 for raising the pressure within the chamber body 1002 from vacuum conditions. Typically, the air or fluid entering the chamber 1000 through the vent 1012 is passed through a filter 1014 to minimize the particles entering the chamber 1000. Such filters are generally available from Camfil-USA, Inc., Riverdale, N.J.

A cassette 1006 is movably disposed in the chamber body 1002 and comprises a lower plate 1016 and an upper plate 1018 coupled to an elevator shaft 1020. The cassette 1006 is configured to support a first substrate 32 on one or more spacers 30 and at least one spacer 50 extending from the lower plate 1016 and a second substrate (not shown) supported on one or more spacers 30 and at least one spacer 50 extending from the upper plate 1018. The cassette 1006 may be raised or lowered to align any one of the substrates supported on the cassette 1006 with the ports 1004.

The chamber body 1002 may also include a cooling plate 1022. The cooling plate 1022 has a plurality of holes that allow the spacers 30, 50 extending from the lower plate 1016 to pass therethrough. As the cassette 1006 is lowered, the substrate 32 seated on the spacers 30, 50 is moved closer to the cooling plate 1022. A heat transfer fluid circulating through the cooling plate 1022 removes heat transferred from the substrate 32 to the cooling plate 1022 thereby reducing the temperature of the substrate 32. Thus, the spacer 50 allows the substrate 32 to expand or contract within the load lock 1000 without marring or otherwise damaging the substrate. One load lock chamber which may be adapted to benefit from the invention is described in U.S. Pat. No. 09/464,362, filed Dec. 15, 1999 (attorney docket no. 3790), which is hereby incorporated by reference in its entirety.

FIG. 10B depicts a sectional view of another embodiment of a load lock chamber 1100 and at least one inner spacer 50 disposed therein. The load lock chamber 1100 generally includes a chamber body 1102 having two glass transfer ports 1104 (only one is shown in FIG. 10B). Each glass transfer port 1104 is selectively sealed by a slit valve 1108 (shown in phantom). The load lock chamber 1100 is disposed between a first atmosphere and a vacuum atmosphere, contained, for example, in chambers (not shown) coupled respectively to the transfer ports 1104, and is utilized to permit transfer of the glass substrate 32 (shown in phantom) into and out of the vacuum atmosphere through adjacent transfer ports 1104 without loss of vacuum.

A plurality of substrates 32 are each supported within the chamber body 1102 on support members 1160 (only one substrate 32 is shown in FIG. 10B for clarity). The support members 1160 may be coupled to the chamber body 1102 or disposed within a movable cassette 1162. In the embodiment depicted in FIG. 10B, a movable cassette 1162 includes at least one spacer 30 and at least one spacers 50 coupled to twelve (12) vertically stacked support members 1160. Thus, as the substrate 32 expands or contracts, the substrate 32 can move over the spacer 50 without marring or otherwise damaging the substrate. One load lock chamber which may be adapted to benefit from the invention is available from AKT, a division of Applied Materials, of Santa Clara, Calif.

While the foregoing is directed to embodiments of the present invention, other and further embodiments of the invention may be devised without departing from the basic scope thereof, and the scope thereof is determined by the claims that follow.

What is claimed is:

1. Apparatus for supporting a substrate in a chamber having at least one substrate support member coupled to the chamber, comprising:
a body having a first portion and a second portion, the first portion adapted to interface with the support member;
a socket disposed in the second portion and having a ball support surface; and
a ball rotatably disposed on the ball support surface in the socket, the ball adapted to contact and support a substrate thereon.

2. The apparatus of claim 1, wherein the bail is coated, plated or electropolished.

3. The apparatus of claim 1, wherein the ball is coated or plated with chromium, an aluminum alloy, silicon nitride, or tungsten nitride.

4. The apparatus of claim 1, wherein the ball support surface has a radius greater than a radius of the ball.

5. The apparatus of claim 1, wherein the ball support surface is conical.

6. The apparatus of claim 1, wherein the ball support surface further comprises:
at least one depression or groove; and
a plurality of ball support balls disposed in the depression or groove that support the ball.

7. The apparatus of claim 1 further comprising:
a plurality of ball support balls disposed between the ball support surface and the ball.

8. Apparatus for supporting a glass substrate, comprising:
a chamber body;
at least one support member coupled to the chamber body; and
one or more balls disposed on the support member, the balls rotatably adapted to support the glass substrate in a spaced-apart relation to the support member.

9. The apparatus of claim 8 further comprising:
a spacer having a first portion and a second portion, the first portion disposed on the support member and the second portion having a socket that rotatably retains the ball therein.

10. The apparatus of claim 9, wherein the socket further comprises:
a ball support disposed inside a cylindrical sidewall.

11. The apparatus of claim 10, wherein the ball support further comprises:
a curved surface having a single contact point with the ball.

12. The apparatus of claim 10, wherein the ball support further comprises:
a conical surface contacting the ball.

13. The apparatus of claim 10, wherein the ball support centers the ball within the socket.

14. The apparatus of claim 8, wherein the ball has a surface roughness of 4 micro-inches or smoother.

15. The apparatus of claim 9 further comprising:
a plurality of mounting pins coupled to the support member, each pin coupled to a respective spacer.

16. The apparatus of claim 15, wherein the first portion is hollow and receives at least a portion of the mounting pin.

17. The apparatus of claim 8, wherein at least one of the balls is positioned to support a center portion of the substrate.

18. The apparatus of claim 8, wherein some of the balls support a perimeter portion of the substrate and at least one of the balls is positioned to support a center portion of the substrate.

19. The apparatus of claim 8, wherein a plurality of spacers having fixed top surfaces support a perimeter portion of the substrate and at least one of the balls is positioned to support a center portion of the substrate.

20. The apparatus of claim 8, wherein the balls are coated, plated or electropolished.

21. The apparatus of claim 8, wherein the balls are coated or plated chromium, an aluminum alloy, silicon nitride, or tungsten nitride.

22. The apparatus of claim 8, wherein each support member further comprises:
a plurality of ball support balls disposed between the support member and the ball.

23. Apparatus for supporting a glass substrate, comprising:
a chamber body;
at least one support member coupled to the chamber body;
one or more balls disposed on the support member, the balls rotatably adapted to support the glass substrate in a spaced-apart relation to the support member; and
a spacer having a first portion and a second portion, the first portion disposed on the support member and the second portion having a socket that rotatably retains the ball therein.

24. The apparatus of claim 23, wherein the socket further comprises:
a ball support surface disposed inside a cylindrical sidewall.

25. The apparatus of claim 24, wherein the ball support surface further comprises:
a curved surface having a single contact point with the ball.

26. The apparatus of claim 24, wherein the ball support surface further comprises:
a conical surface contacting the ball.

27. The apparatus of claim 24, wherein the ball support surface centers the ball within the socket.

28. The apparatus of claim 23, wherein the ball has a surface roughness of 4 micro-inches or smoother.

29. The apparatus of claim 23 further comprising:
a plurality of mounting pins coupled to the support member, each pin coupled to a respective spacer.

30. The apparatus of claim 29, wherein the first portion is hollow and receives at least a portion of the mounting pin.

31. The apparatus of claim 23, wherein at least one of the balls is positioned to support a center portion of the substrate.

32. The apparatus of claim 23, wherein the plurality of spacers include a first group having a non-rotating surface supporting a perimeter portion of the substrate and a second group having balls supporting a center portion of the substrate.

33. The apparatus of claim 23, wherein the balls are coated, plated or electropolished.

34. The apparatus of claim 23, wherein the balls are coated or plated chromium, an aluminum alloy, silicon nitride, or tungsten nitride.

35. The apparatus of claim 23, wherein the chamber body is a thermal treatment chamber.

36. The apparatus of claim 23, wherein the chamber body further comprises:
a first substrate transfer port disposed on a first sidewall; and
a second substrate transfer port disposed on a second sidewall.

37. The apparatus of claim 23, wherein the chamber body further comprises:
a first substrate transfer port disposed on a first sidewall; and
a second substrate transfer port disposed on a second sidewall.

38. The apparatus of claim 23 further comprising:
a plurality of ball support balls disposed between a ball support surface of the support member and the ball.

39. The apparatus of claim 23, wherein the ball moves laterally relative to the support member.

40. Apparatus for supporting a glass substrate, comprising:
a substrate heating chamber having at least one sidewall;
a plurality of support members coupled to the sidewall;
at least one spacer disposed on each support member, the spacer having a first portion and a second portion, the first portion disposed on the support member and the second portion having a socket; and
a ball rotatably disposed in the socket and adapted to support the glass substrate in a spaced-apart relation to the support member.

41. The apparatus of claim 40, wherein the substrate heating chamber is an annealing chamber.

42. The apparatus of claim 40 further comprising:
a plurality of ball support balls disposed between a ball support surface of the socket and the ball.

43. The apparatus of claim 40, wherein the ball moves laterally and/or rotates relative to the socket.

44. Apparatus for supporting a glass substrate, comprising:
a load lock chamber having a first substrate transfer port disposed in a first sidewall and second substrate transfer port disposed in a second sidewall;
at least one support member disposed in the chamber;
at least one spacer disposed on the support member, the spacer having a first portion and a second portion, the first portion disposed on the support member and the second portion having a socket; and
a ball rotatably disposed in the socket and adapted to support the glass substrate in a spaced-apart relation to the support member.

45. The apparatus of claim 44 further comprising:
a plurality of ball support balls disposed between a ball support surface of the socket and the ball.

46. The apparatus of claim 44, wherein the ball moves laterally and/or rotates relative to the socket.
